(19) United States
(12) Patent Application Publication
(10) Pub. No.: US 2026/0154296 A1
(43) Pub. Date: Jun. 4, 2026

(54) SYSTEMS AND METHODS TO MANAGE UNSTRUCTURED DATA

(71) Applicant: Ohalo Limited, Bicester (GB)

(72) Inventors: Kyle DuPont, Marietta, GA (US); Alistair Jones, London (GB)

(73) Assignee: Ohalo Limited, Bicester, EN (GB)

(21) Appl. No.: 18/966,349

(22) Filed: Dec. 3, 2024

(51) Int. Cl. G06F 16/31; G06F 16/355

(52) U.S. Cl. CPC G06F 16/313; G06F 16/355

(57) ABSTRACT

A system including a transceiver and a processor is disclosed. The transceiver may obtain a user request to categorize a document via a user interface. The user request includes a list of categories to categorize the document. The processor may obtain the user request to categorize the document from the transceiver, and obtain document information associated with the document to be categorized responsive to obtaining the user request. The processor may generate a prompt for a large language model (LLM) based on the user request. The prompt includes the list of categories (optionally) and the document information. The processor may transmit the prompt to the LLM to identify a category for the document from the list of categories, and obtain an output from the LLM responsive to transmitting the prompt and the document information. The processor may display the output on the user interface.

### FIELD

The present disclosure relates to data management and analysis, and more particularly to systems and methods to manage and analyze unstructured data.

### BACKGROUND

Structured data is organized in a specific format (e.g., in databases, datasets, spreadsheets, etc.), which makes it easily readable and understandable by both humans and machines. There exist different techniques that collect, process, and analyze structured data. Such techniques may also extract insights from large amounts of structured data.

Unstructured data, on the other hand, may not have a specific format and/or structure, which makes it difficult to organize, analyze, and interpret the unstructured data. With the explosive growth of unstructured data, organizations often struggle to understand what data they have, where it resides, and how it's structured. In addition, poor data quality can lead to incorrect insights and business decisions.

Thus, there exists a need for a system and method to efficiently manage and analyze unstructured data at a large scale, which may enable organizations to truly gain valuable insights into their unstructured data landscape.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a first snapshot of a user interface in accordance with the present disclosure.

FIG. 3 depicts an example prompt to categorize document(s) in accordance with the present disclosure.

FIG. 4 depicts a second snapshot of a user interface in accordance with the present disclosure.

FIG. 5 depicts a third snapshot of a user interface in accordance with the present disclosure.

FIG. 6 depicts a process to perform annotation in accordance with the present disclosure.

FIG. 7 depicts a fourth snapshot of a user interface in accordance with the present disclosure.

FIG. 8 depicts a flow diagram of a method to perform data management in accordance with the present disclosure.

### DETAILED DESCRIPTION

### Overview

The present disclosure describes a system and method to perform data management and analysis of unstructured data at a large scale. In some aspects, the system may facilitate data discovery, data ingestion, data annotation, file activity monitoring, sensitive data monitoring/redaction, data classification/categorization, data risk evaluation, data source monitoring, etc., of the unstructured data. Furthermore, the system may analyze the unstructured data and generate valuable insights from the unstructured data at a large scale.

In some aspects, the system may communicatively couple with a plurality of data sources. Each data source may include one or more documents/files or unstructured data (and/or structured data). The unstructured data may include text documents (such as emails, articles, invoice, curriculum vitae (CV), etc.), multimedia files (such as images, audio, video files), and/or the like. The system may extract data from the data source(s), and may store the extracted data in a system memory for further analysis. In addition, the system may communicatively couple with a plurality of Large Language Models (LLMs) that may enable the system to perform different tasks described in the present disclosure. Stated another way, the system may leverage the LLMs to perform the different tasks described in the present disclosure.

In some aspects, the system may categorize a document (or multiple documents) in a category from a list of categories, which may enable a user to view or gauge the document details without having to open the document. In some aspects, the system may receive the list of categories from the user. Each category in the list of categories may include a category name (e.g., “CV”, “invoices”) in which the user desires to categorize a set of documents. In further aspects, each category may include description/characteristics of respective category. In some aspects, the description/characteristics may include a combination of keywords that describes contextual text/characteristics associated with the category.

In some aspects, the system may obtain the list of categories from the user device (or the user interface), and obtain document information (e.g., a document path, document content etc.) associated with the document to be categorized. Responsive to obtaining the list of categories and the document information, the system may generate a prompt (e.g., a first prompt) for the LLM. In some aspects, the prompt may include a first instruction to categorize the document (or identify a relevant category for the document from the list of categories), the list of categories (including the category names and respective description/characteristics), the document information associated with the document to be categorized (e.g., the document path, document content, etc.). In further aspects, the prompt may include information associated with previously categorized documents (that may have been categorized in the past by the LLM), and a second instruction to identify the relevant category based on the previously categorized documents or previously identified categories. In addition, the prompt may include a third instruction to add a new category when the list of categories provided by the user may not be relevant for the document, and a fourth instruction to expand a category by tweaking/modifying the category description.

Responsive to generating the prompt, the system may transmit the prompt to the LLM. The LLM may receive the prompt and may identify the relevant category for the document, and transmit an output to the system. The system may receive the output and display the output on the user interface. The system may store a final category list (including the list of categories and the new category identified by the LLM) in the system memory. The system may use the final category list to categorize other documents in the future (or at a later stage). The system may further store the LLM output, the prompt, the list of categories, etc. in the system memory.

In accordance with the present disclosure, the system may further perform Name Entity Recognition (NER) and/or annotation of a document (or a plurality of documents) ingested by the system. NER is a process that identifies and classifies named entities in the document, and annotation is a process to indicate where in the document the named entities are located. The annotation process may include marking (e.g., highlighting or underlining) the named entities and adding tags/labels to the marked named entities. In some aspects, the system may leverage one or more LLMs to perform the NER and annotate the document.

In some aspects, the system may generate a prompt (e.g., a second prompt) for the LLM to annotate the document. The prompt may include an instruction to perform annotation of the document and information associated with the document (e.g., the document content). The prompt may further include a request to return additional information about the entity the LLM may be annotating, to achieve character level precision in annotations (or to determine the location of the text/word annotated by the LLM in the document precisely). In some aspects, the additional information may include a starting character index (or startIndex) associated with the text/word, an ending character index (or endIndex) associated with the text/word, and a snippet of the text that the LLM may be annotating. The snippet may include one or more tokens before the start of the annotations and one or more tokens after the end of the annotations. Stated another way, the system may generate the prompt to capture the contextual text/information associated with the text/words (associated with the entity) within the document.

The LLM may receive the prompt from the system, and perform the annotation and return an annotated document and the additional information to the system. The system may obtain the annotated document and the additional information from the LLM. The system may then use the annotated document and the additional information to perform regular string matching with the original document, to verify the LLM output accuracy and update the annotation accordingly if the accuracy is below a predefined threshold.

In accordance with the present disclosure, the system may further identify and redact (e.g., remove or hide) sensitive information from one or more documents with higher levels of accuracy. In some aspects, the system may identify the sensitive information based on user inputs, and may perform a first redaction pass in which the system may redact the sensitive information based on the user inputs. The system may then store the identified sensitive data tokens responsive to replacing the sensitive information. The system may then utilize the identified sensitive data tokens responsive to replacing the sensitive information to create a variation of the identified sensitive data tokens (e.g. initials, acronyms, alternative spellings or short versions of the same text). The system may then perform a second pass redaction in which the system re-scans the document and redacts additional sensitive information based on the variation of the identified sensitive data tokens, to accurately redact the sensitive information from the document.

The present disclosure discloses a data management and analysis system (or a data management and analysis platform) that facilitates document discovery, classification, and redaction at a large scale. Specifically, the system facilitates discovery, classification, and redaction for unstructured data. The system empowers an organization to understand and manage unstructured data, make better decisions, ensure data quality and compliance, and unlock the full potential of its data assets. By leveraging cutting-edge techniques across the pipeline, the system unlocks transformative insights from content at terabyte scale. In addition, the use of LLMs further enables the system to perform different tasks under a single platform at a large scale, and to increase processing speed to perform the tasks.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

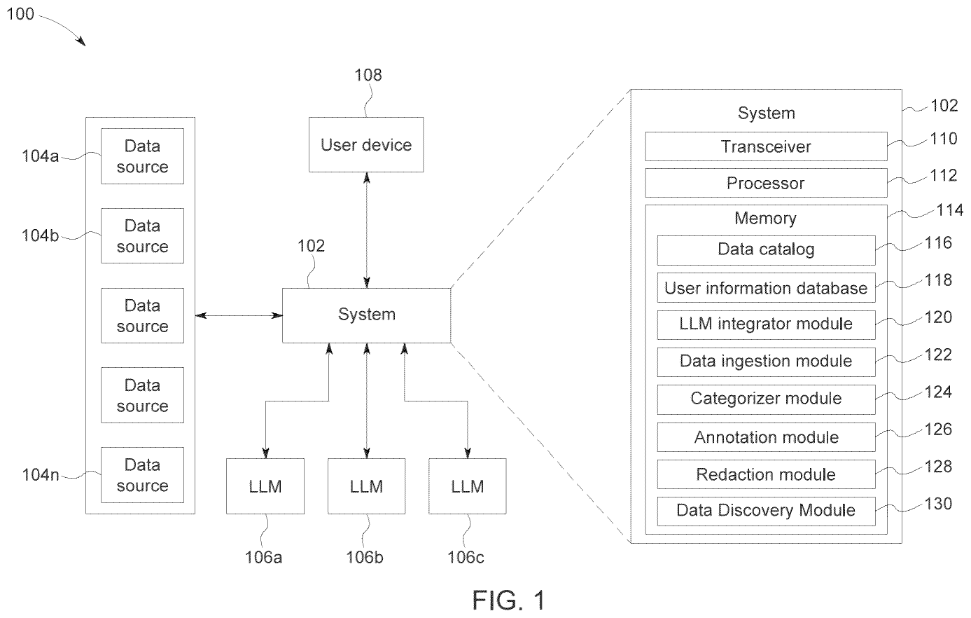

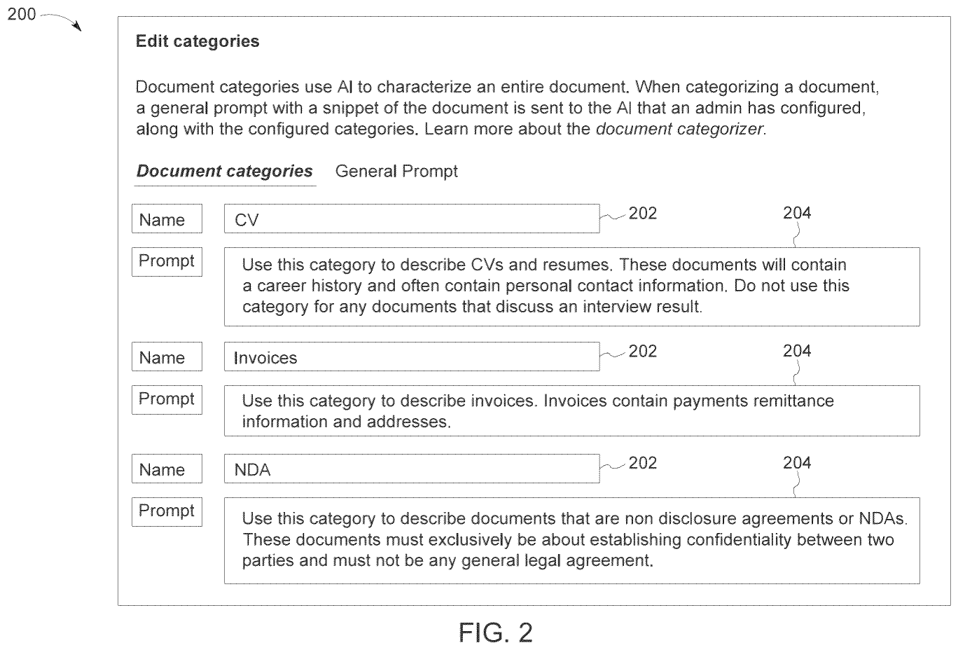

FIG. 1 depicts an environment 100 in which techniques and structures for providing the systems and methods disclosed herein may be implemented. While describing FIG. 1, the reference is made to FIGS. 2-7.

The environment 100 may include a system 102 that may be hosted on a server or a distributed computing system. The system 102 may facilitate data management and analysis of unstructured data at a large scale, which may be associated with an organization (e.g., a company, an institution, an association, a government body, and/or the like). For instance, the system 102 may facilitate data discovery, data ingestion, data annotation, file activity monitoring, sensitive data monitoring/redaction, data classification/categorization, data risk evaluation, data source monitoring, etc., of unstructured data at a large scale or at a large volume. Furthermore, the system 102 may analyze the unstructured data and generate valuable insights from the unstructured data. The system 102 may empower the organization to understand and manage the unstructured data, make better decisions, ensure data quality and compliance, and unlock the full potential of its data assets. In some aspects, the system 102 may leverage machine learning and natural language processing techniques to perform the above-recited operations.

The unstructured data may be a data that does not have a predefined data model or structure. The unstructured data may not have a specific format, and may not be organized in a proper structure (e.g., in rows and columns). The unstructured data may include, for example, text documents (such as emails, articles, invoices, curriculum vitae (CV), etc.), multimedia files (such as images, audio, video files), and/or the like. Examples of unstructured data described herein are for illustrative purpose only, and should not be construed as limiting.

The system 102 may communicatively couple with a plurality of devices/servers including, but not limited to, a plurality of data sources 104a, 104b, . . . 104n (collectively referred to as data sources 104), a plurality of Large Language Models (LLMs) 106a, 106b, 106c (collectively referred to as LLMs 106), a user device 108, and/or the like. The data sources 104 may include, but are not limited to, network drives, Google™ Workspace™, Office 365™, on-premise SharePoint™, Salesforce™, Azure™ and AWS™ blob storage, SSH connections, email and Slack™ archives, and/or the like. The LLMs 106 may include LLMs to perform tasks such as data ingestion, data annotation, sensitive data monitoring/redaction, data classification/categorization, and/or the like. The LLMs 106 may be machine learning models that may comprehend and generate human language text. The LLMs 106 may receive a prompt (e.g., a user prompt) in natural language and may perform one or more operations based on the received prompt. The user device 108 may include, for example, a mobile phone, a laptop, a computer, a tablet, a wearable device, or any other device with communication capabilities. In some aspects, the system 102 may be hosted on the user device 108.

In some aspects, the data sources 104 and/or the LLMs 106 may be hosted on another server (that may be different from the server that hosts the system 102). In other aspects, the data sources 104 and/or the LLMs 106 may be part of the system 102 (or hosted on the same server as the system 102). In some aspects, the system 102 may communicatively couple with the data sources 104 and the LLMs 106 via one or more network(s) (not shown). In further aspects, the system 102 may use application programming interface (API) to access respective data sources and/or the LLMs, via the network(s).

The network(s), as described here, illustrates an example communication infrastructure in which the connected devices discussed in various embodiments of this disclosure may communicate. The network(s) may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 102 may include a plurality of components including, but not limited to, a transceiver 110, a processor 112 (or one or more processors), a memory 114, and/or the like, which may communicatively couple with each other. The transceiver 110 may transmit/receive information/data to/from external systems and devices, via the network. For example, the transceiver 110 may receive data from the data sources 104. The transceiver 110 may further receive user inputs (e.g., a user request or query) in natural language from the user device 108, which may enable the user to conveniently interact with the system 102 in natural language. In some aspects, the user query may not be in natural language, and may instead include or be in the form of an image, a document, speech, and/or the like. In addition, the transceiver 110 may facilitate communication with the LLMs 106, via the API. Furthermore, the transceiver 110 may transmit a data/instruction (e.g., a response to the user's query in natural language) to the user device 108.

The processor 112 may utilize the memory 114 to store programs in code and/or to store data for performing aspects in accordance with the disclosure. The memory 114 may be a non-transitory computer-readable storage medium or memory storing a program code that enables the processor 112 to perform operations in accordance with the present disclosure. The memory 114 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 114 may include/store a plurality of databases and modules including, but not limited to, a data catalog 116, a user information database 118, an LLM integrator module 120, a data ingestion module 122, a categorizer module 124, an annotation module 126, a redaction module 128, a data discovery module 130, and/or the like. In alternative aspects, one or more modules described above may be stored outside the memory 114. The data catalog 116 may store the data obtained from the data sources 104. The user information database 118 may store the data/information associated with the user, including user query/prompt(s). The modules such as the LLM integrator module 120, the data ingestion module 122, the categorizer module 124, the annotation module 126, the redaction module 128, and the data discovery module 130 may be stored in the form of computer-executable instructions, and the processor 112 may execute the stored computer-executable instructions for performing functions/operations in accordance with the present disclosure. In some aspects, the LLM integrator module 120 may facilitate the system 102 to integrate with the LLMs 106 (e.g., to enable interaction with the LLMs 106, via the API). The functions of other modules are described later in the description below.

The processor 112 may execute the instructions stored in the data ingestion module 122 to enable ingestion of the unstructured data (and/or the structured data) from the data sources 104. The ingestion process may include extracting a plurality of documents (having unstructured data) from the data sources 104 and storing the data in the data catalog 116. The ingestion process may include obtaining the data in real-time and storing the data for further analysis. In some aspects, the user may select the one or more data sources of the data sources 104 (e.g., via the user device 108), and the processor 112 may extract/obtain the data/documents from the selected data sources. In an exemplary aspect, the processor 112 may utilize one or more asynchronous crawlers optimized for performance across multiple data sources 104 to discover remote files and fetch content while respecting quota policies and handling errors. The ingestion process may further include a data parsing process that extracts text, images, and metadata from the extracted documents/data, in multiple file formats using format-specific techniques (e.g., via format-aware shredders). In some aspects, the processor 112 may use custom decoders (that utilize deep learning) for optical character recognition in scanned/parsed documents and computer vision in image files. In some aspects, the processor 112 may execute the instructions stored in the data ingestion module 122 to leverage ETL (Extract, Transform, Load) pipeline to extract/obtain the data or documents from the data sources 104, transform the obtained data (including performing the steps of data cleaning, formatting, and standardizing), and load/index the data in the memory 114.

The processor 112 may further execute the instructions stored in the categorizer module 124 to analyze and categorize/classify a document (or more than one document) of the plurality of documents in a category/label from a list of categories. The categories may include, but are not limited to, “invoice”, “CV”, “Non-Disclosure Agreement (NDA)”, “customer profile”, “payment receipt”, “job description”, “medical records”, “financial records”, “personal/employee records”, and/or the like. In further aspects, the categories may include domains such as “medical”, “construction”, “finance”, and/or the like.

In some aspects, the user may generate/transmit a user request (e.g., a “first user request”) to categorize one or more documents, via a user interface 200 (as shown in FIG. 2) associated with the user device 108. In some aspects, the user may select a document from the plurality of documents ingested by the system 102/processor 112 from the data sources 104. The user device 108 may receive the user request and may transmit the user request to the transceiver 110. The transceiver 110 may receive the user request from the user device 108, and may transmit the user request to the processor 112. In some aspects, the transceiver 110 may store the user request in the memory 114 (e.g., in the user information database 118).

The processor 112 may obtain the user request from the user device 108, via the transceiver 110. The processor 112 may additionally obtain a list of categories to categorize the document from the user, via the user interface 200. In some aspects, the user request may include the list of categories (or a list of user-defined categories).

In some aspects, each category, in the list of categories, may include a category name in which the user desires to categorize a set of documents. For instance, the user may provide categories “CV” and “invoice” in the user request. In further aspects, each category may include description/characteristics of respective category. In some aspects, the description/characteristics may include a combination of keywords that describes contextual text/characteristics associated with the category.

In an exemplary aspect, the user may provide the category names in a first field 202 and provide the description/characteristics in a second field 204 displayed on the user interface 200, as shown in FIG. 2. As an example, the user may provide the category name “CV” in the first field 202 and its definition/characteristics in the second field 204. The definition/characteristics associated with the name “CV” may include text such as “Use this category to describe CVs and resumes. These documents will contain a career history and other personal contact information.” As another example, the user may provide the category name “invoices” in the first field 202 and its definition/characteristics (to be provided in the second field 204) may include text such as “Use this category to describe invoices. Invoices contain payments remittance information and addresses”. The user may similarly add multiple categories with their respective names and description/characteristics in the user interface 200 as part of the user request. In some aspects, the user may further update the user request at a later stage to enable the system 102 (or the processor 112) to accurately perform the categorization of documents ingested from the data sources 104.

Responsive to obtaining the user request as described above, the processor 112 may obtain first document information associated with the selected document to be categorized. In some aspects, the first document information may include document content/text (e.g., a text string representing document content), a document path (that indicates the storage document location in the system 102/memory 114), etc. In one exemplary aspect, the processor 112 may obtain the first document information from the memory 114. In this case, the first document information may be stored in the memory 114 (e.g., in the data catalog 116). In other aspects, the user request may include the first document information. In another aspect, the user request may include the document path. The processor 112 may fetch/obtain the document from the data catalog 116 by using the document path provided in the user request.

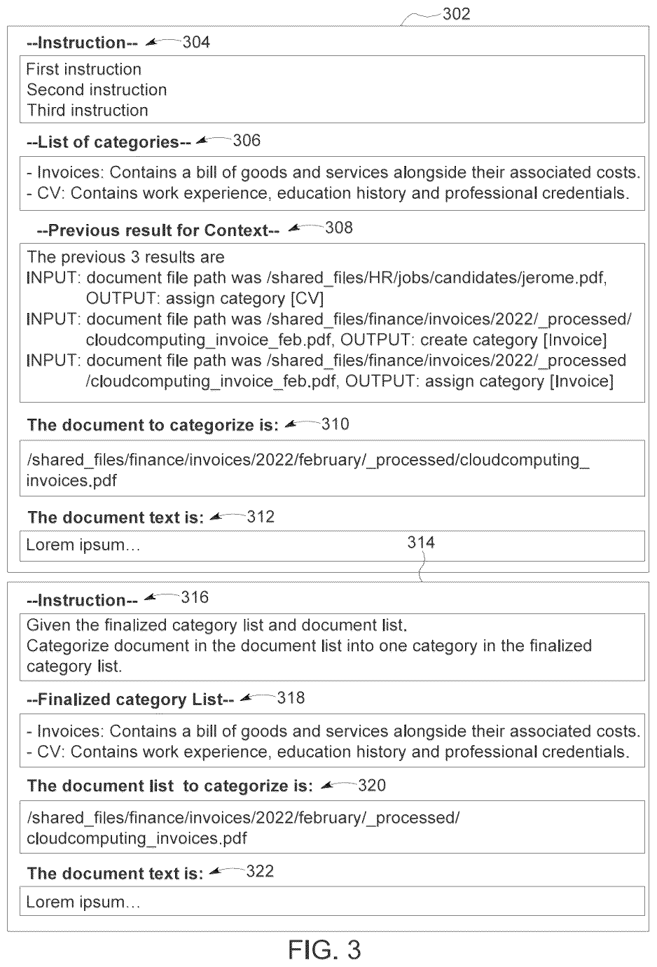

Responsive to obtaining the list of categories and the first document information (or the user request), the processor 112 may execute the instructions stored in the categorizer module 124 to generate a first prompt 302 (shown in FIG. 3) for an LLM (e.g., the LLM 106a) based on the user request. The processor 112 may leverage the LLM 106a to categorize the document (or the plurality of documents) in the list of categories. Stated another way, the processor 112 may leverage the LLM 106a to identify a relevant category for the document from the list of categories provided by the user. In some aspects, the processor 112 may select an optimal LLM (i.e., the LLM 106a) from the plurality of LLMs 106 to categorize the document.

The first prompt 302 may be a generalized prompt and may not be specific to any LLM. The first prompt 302 may be in natural language. In some aspects, the first prompt 302 may enable the LLM 106a to build a finalized category list (or a category taxonomy) to categorize the document (or the plurality of documents), and then categorize the document(s) in the finalized category list.

The first prompt 302 may include a plurality of fields that may enable the LLM 106a to perform document categorization or identify a relevant category from the finalized category list for the document. In some aspects, the first prompt 302 may include an instruction 304 to instruct the LLM 106a to categorize the document. In some aspects, the instruction 304 may include a first instruction to select a category from the list of categories provided by the user to categorize the document. The instruction 304 may further include a second instruction to add a new category to the list of categories when the list of categories (provided by the user) is not relevant for the document or when the LLM 106a is unable identify a relevant category from the list of categories provided by the user for the document. The instruction 304 may further include a third instruction to modify a category of the list of categories provided by the user to categorize the document. For instance, the third instruction may include an instruction to expand a category by tweaking/modifying the respective category's description/characteristics.

In an exemplary aspect, the overall instruction 304 may be as follows.
“(a) You are an expert in categorizing documents and proposing new category names.
(b) Your job is to assign a category to the document provided below, either by selecting a category from the list provided, or if you do not think that there is an appropriate category, you may either 1) expand a category by tweaking its definition or 2) add a new category to the category list.
(c) You can make your decision based on the document file path and the document contents. You will also be provided with the previous n document you have seen for additional context.”

The first prompt 302 may further include the list of categories provided by the user (shown as a list of categories 306 in FIG. 3). As described above, each category in the list of categories 306 may include a category name and respective category description/characteristics, which may enable the LLM 106a to understand the relevance of each category and how the user may desire the LLM 106a to categorize the document. In addition, the first prompt 302 may include the first document information described above. As described above, the first document information may include a document path 310 (or a document file path) associated with the document to be categorized. The first document information may further include document content/text 312 (e.g., a text string representing the document content).

In some aspects, the first prompt 302 may further include second document information 308 associated with a set of previously categorized documents. The second document information 308 may include previous results for context. In some aspects, the second document information 308 may include document paths of each of the previously categorized documents, and associated category names. In further aspects, the second document information 308 may include content associated with each of the previously categorized documents.

For instance, the first prompt 302 may include information associated with three previously categorized results/documents that may have been categorized by the LLM 106a. The information may include text such as “INPUT: document file path was /shared_files/HR/jobs/candidates/jerome.pdf, OUTPUT: assign category [CV]”. Such information may enable the LLM 106a to identify the category for the document using the document path (or context associated with the document path). In such cases, the LLM 106a may correlate the document path mentioned in the first document information and the second document information to categorize the document. For instance, the LLM may correlate both the paths, and determine that both the paths are associated with “invoices”. If, in this case, the previously categorized document was categorized under “invoices”, the LLM 106a may identify the category “invoices” for the selected document as well.

Responsive to generating the first prompt 302 as described above, the processor 112 may transmit the first prompt 302 to the LLM 106a to categorize the document based on the first prompt 302 (or to identify a category for the selected document). The LLM 106a may receive the first prompt 302, categorize the document based on the first prompt 302, and transmit an output to the system 102 (e.g. to the transceiver 110). The output may include a categorized set of documents or the selected document categorized into the identified category. Specifically, the output may include a category identifier (e.g., a category name such as “CV”, “invoices” etc.) for the selected document. The category name may be associated with (or be a part of) the list of category names, or may be associated with a new category identified by the LLM 106a. The output may further include a mapping of a document identifier (e.g., a document name/ID) associated with the selected document and the corresponding category identifier. The transceiver 110 may receive the categorization (or the output) from the LLM 106a responsive to transmitting the first prompt 302, and may store the output in the memory 114 (e.g., in the data catalog 116).

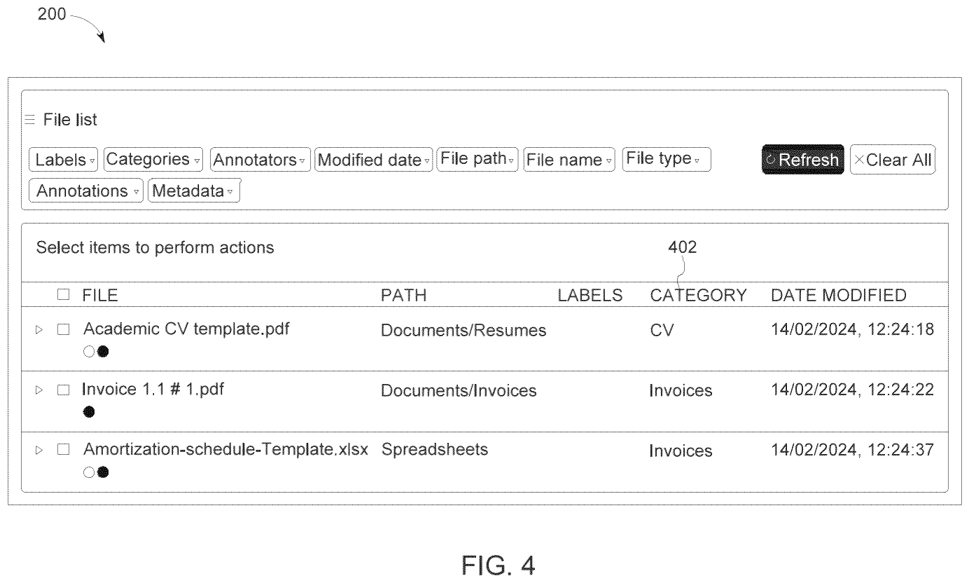

In some aspects, the processor 112 may obtain the output from the transceiver 110 and display the output on the user interface 200, as shown in FIG. 4. The output may include the category name (as shown in a column 402 of FIG. 4). In some aspects, the system 102 (e.g., the transceiver 110 or the processor 112) may receive and display the categorization of multiple documents on the user interface 200 in real-time (or catalog the categorized documents one by one). The processor 112 may aggregate the categorization at a large scale and store the categorization in the memory 114 (e.g., in the data catalog 116).

The processor 112 may further store the first prompt 302 in the memory 114 (e.g., in the user information database 118 or any other location). In further aspects, the processor 112 may store a finalized category list (including the list of categories provided by the user and the new category identified/suggested by the LLM 106a) in the memory 114 (e.g., in the user information database 118 or any other location).

Furthermore, the user may use the finalized category list to categorize another document or a next set of documents. In such scenarios, the user may select the other document and the finalized category list, and may request the processor 112 to categorize the other document according to the finalized category list. The processor 112 may obtain the user request (e.g., a “second user request”) to categorize the other document from the user device 108. The processor 112 may further obtain the finalized category list from the memory 114, and third document information associated with the other document to be categorized.

The processor 112 may then generate a second prompt 314 (shown in FIG. 3) for the LLM 106a, and transmit the second prompt 314 to the LLM 106a, as described above to receive the categorization of the other document from the LLM 106a. The second prompt 314 may include another instruction 316 to instruct the LLM 106a to categorize the other document (or the next set of documents) using the finalized category list. The second prompt 314 may further include the finalized category list (shown as category list 318 in FIG. 3), and the third document information. The third document information may include a document path 320 (or a document file path) associated with the other document to be categorized. The third document information may further include document content/text 322 (e.g., a text string representing the other document content). In this case, the LLM 106a may categorize the document by using the already-prepared category list (i.e., the finalized category list) and the user may not be required to provide the category name and respective description/characteristics every time.

The processor 112 may obtain the categorization of documents from the LLM 106a, and display the categorization of multiple documents on the user interface 200. The user may view the categorization (that indicates the document details) without opening the document. Stated another way, the user may understand what a document is without having to open and read it. The user may view the categorization at a scale to derive valuable insights from the categorization.

Furthermore, the system 102 may not be required to retrain or fine-tune the LLMs. The system 102 may receive the user prompt, and use the user prompt to categorize the set of documents via the respective LLM. The system 102 may support advanced smart label query functionality, grouping of categories into label sets (or categories), allowing for more nuanced and context-aware categorization of documents.

In further aspects, the system 102 may enable the user to prepare a taxonomy, via the categorizer module 124. The taxonomy may be used to categorize documents (e.g., a set of documents) in a structured hierarchy to organize and manage the documents. The taxonomy may include categories and subcategories at different levels. For instance, a first level associated with the taxonomy may include domains such as “finance”, “human resources”, “legal”, etc. A second level associated with the finance category may include categories such as “invoices”, “financial records”, etc.; a second level associated with the human resources category may include categories such as “CVs”, “training:, etc. As another example, the first level may include domains such as “medical”, “construction”, etc. and the second level may include their respective sub-categories.

In some aspects, the user may interact with the system 102 (or the processor 112) to provide the first level categories and the second level categories. Stated another way, the user defined categories (or the list of categories provided by the user) may include the first level categories and the second level categories. In an exemplary aspect, the user may provide the first level categories and the second level categories simultaneously (along with their respective definition/characteristics). Alternatively, the user may provide the first level categories and the second level categories sequentially. For instance, the user may first submit or transmit the first level categories to the processor 112 (via the transceiver 110), and then the processor 112 may request the user to provide the respective second level categories. The user may then provide the second level categories to the processor 112, via the transceiver 110. Once the processor 112 receives the first level categories and the second level categories, the processor 112 may submit a request to respective LLM to categorize the set of documents in the first level categories and the second level categories, in the similar manner as described above.

In alternative aspects, the processor 112 may receive the first level categories, along with their respective definition/characteristics, from the user device 108. The processor 112 may then automatically generate the second level categories (and respective third level categories) for the respective first level categories. In some aspects, the processor 112 may generate a plurality of second level categories for the respective first level categories. The processor 112 may then transmit the plurality of second level categories to the user device 108 for confirmation. The user may view the plurality of second level categories and may select a set of second level categories from the plurality of second level categories based on user preference. The processor 112 may receive the user selected categories (or the set of second level categories) from the user device 108, and then request the respective LLM to categorize the set of documents in the first level categories and the set of second level categories. Thus, the processor 112 may create an expanded taxonomy itself, based on the first level categories (e.g., the domain), and then iteratively prune the expanded taxonomy to create an iteratively pruned chain taxonomy based on user preferences.

In accordance with further aspects of the present disclosure, the processor 112 may leverage another LLM (e.g., the LLM 106b) to perform a Name Entity Recognition (NER) and/or an annotation of a document (or a plurality of documents) ingested by the system 102 from the data sources 104. NER is a natural language processing (NLP) task that identifies and classifies named entities in the document (that includes a string of text). The NER may recognize named entities and sort them into entity types such as person names, email IDs, organizations (or organization names), locations, medical codes, time expressions, quantities, monetary values, and/or the like. For instance, if a sentence in a document includes the word “Apple”, the NER may determine whether the word “Apple” is just apple the fruit or the company “Apple”. Stated another way, the NER may identify named entities in the document and classify them into the entity types (e.g., person names, email IDs, etc.).

A document may include one or more named entities. Annotation may be a process of indicating where in the document the named entities are located. The annotation process may include marking (e.g., highlighting or underlining) the named entities and adding tags/labels to the marked named entities. The tags/labels may be associated with the identified entity types. For example, the annotated document may highlight the word “Apple” and add a label “organization” based on the inputs obtained from the NER.

In accordance with the present disclosure, the processor 112 may execute the instructions stored in the annotation module 126 to perform the NER and/or annotate the document. In some aspects, the processor 112 may receive a user request (e.g., a “third user request”) to perform NER of one or more documents, via the user device 108 and the transceiver 110. In some aspects, the user may select a data source from the plurality of data sources 104 from where the documents may be fetched, via the user interface 200. When the user selects the data source, the processor 112 may receive the user request to perform the NER of the documents associated with or stored at the selected data source. The processor 112 may then execute the instructions stored in the annotation module 126 to perform the NER.

When the processor 112 executes the instructions stored in the annotation module 126, the processor 112 may extract text associated with the document(s) and generate a prompt (e.g., a third prompt) for the LLM 106b to perform the NER. The LLM 106b may receive the prompt and identify one or more named entities in each document and classify the named entities into respective entity types based on the prompt. In some aspects, the prompt may include an instruction to perform the NER of the documents. In addition, the prompt may include information associated with the documents (e.g., document content). The LLM 106b may generate an outcome associated with the NER (e.g., the named entities and tags/entity types associated with each document) and transmit the outcome to the processor 112, via the transceiver 110. The processor 112 may receive the outcome from the LLM 106b, generate an output, and transmit the output to the user device 108 to display the output on the user interface 200.

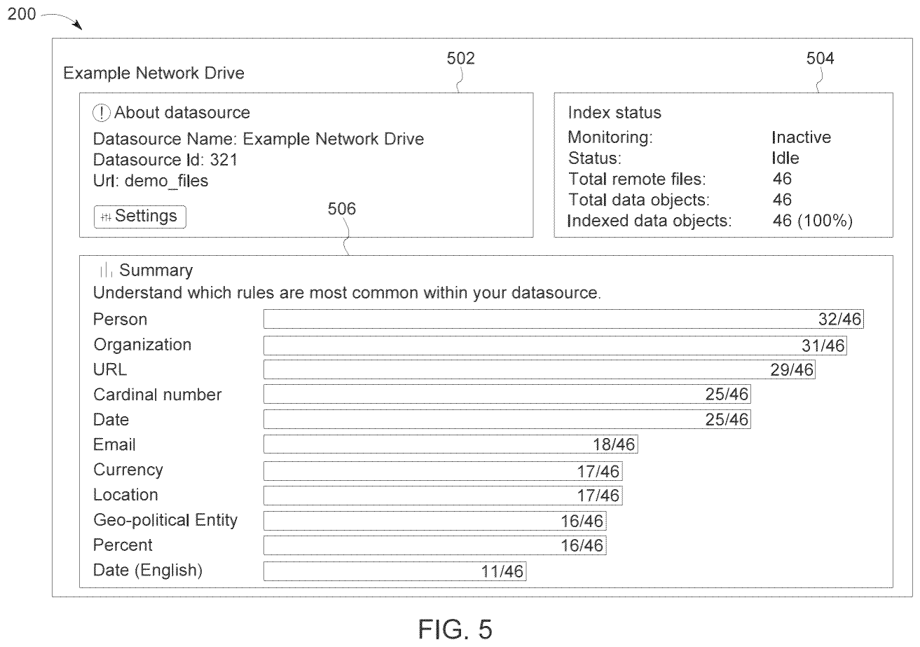

An example output associated with NER is shown in FIG. 5. The output may include data source information 502, which may include a data source identifier (e.g., a data source name, ID, etc.). The output may further include an index status 504, which may include ingestion process status associated with the data source. For instance, the index status 504 may include a count of documents/files that are ingested/indexed from the data source by the system 102. The output may further include a summary section 506, which may indicate an outcome summary generated by the LLM 106b. For instance, the summary section 506 may include different types of entity tags / types identified by the LLM 106b in the document, which may include, for example, person names, organizations, dates, emails, URLs, currencies, locations, and/or the like. In addition, the summary section 506 may indicate a count of documents, out of the total number of documents ingested by the system 102 from the data source, associated with each entity type. For example, the summary section 506 may indicate a count of documents having “person” as an entity tag.

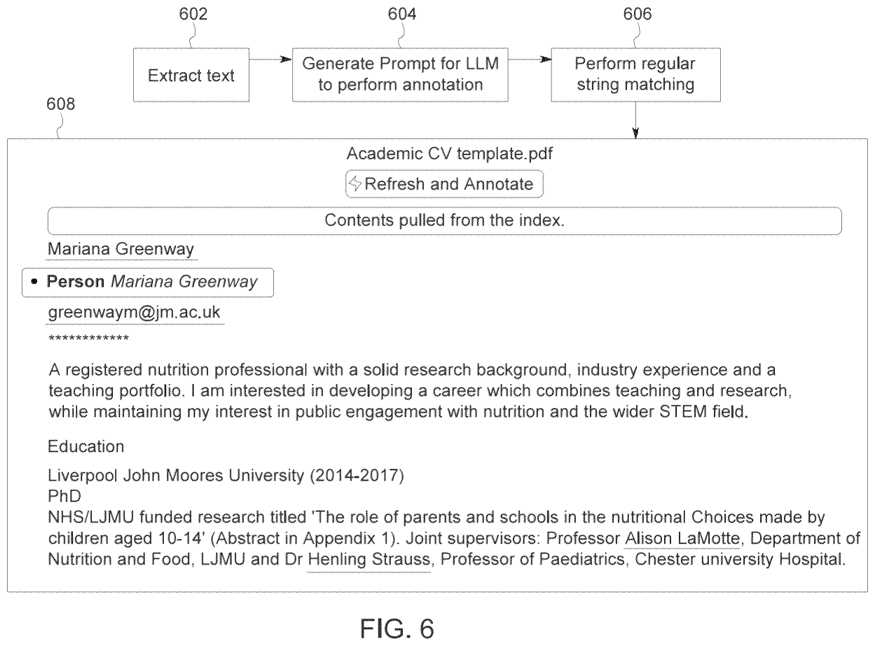

In some aspects, the user may select a document (e.g., an email) from the documents associated with the data source and request the processor 112 to perform the annotation. When the processor 112 receives the user request (e.g., a “fourth user request”) to annotate the document, the processor 112 may execute the instructions stored in the annotation module 126 to perform the annotation. When the processor 112 executes the instructions stored in the annotation module 126, the processor 112 may extract the text associated with the document, as shown in a block 602 of FIG. 6. The processor 112 may then generate a prompt (e.g., a fourth prompt) for the LLM 106b to perform the document annotation, as shown in a block 604. Stated another way, the processor 112 may leverage the LLM 106b to perform the annotation.

In some aspects, the prompt may include an instruction to perform the document annotation. The prompt may further include information associated with the document (e.g., document content). The prompt may additionally include a request for the LLM 106b to return additional information about the entity (e.g., text/word “date”) that may be annotated by the LLM 106b. The additional information may enable the processor 112 to achieve a character level precision in annotations (or to determine text/word location in the document precisely). In some aspects, the additional information may include a starting character index (or a startIndex) associated with the text/word, an ending character index (or an endIndex) associated with the text/word, and a snippet of the text that the LLM 106b may be annotating. The snippet may include several tokens before the start of the annotations and several tokens after the end of the annotations. For example, the snippet may include a first couple of words before the start of the annotations (e.g., words/phrases before the word “date”) and the next couple of words after the end of the annotations (e.g., words/phrases after the word “date”). Thus, the processor 112 may generate the prompt to capture the “contextual” text/information associated with the text/words within the document that the LLM 106b may be annotating.

The processor 112 may transmit the generated prompt to the LLM 106b. The LLM 106b may receive the prompt from the processor 112, via the transceiver 110. Responsive to receiving the prompt, the LLM 106b may perform the annotation and return an annotated document and the additional information described above to the processor 112. The processor 112 may obtain the annotated document and the additional information from the LLM 106b. The processor 112 may then use the annotated document and the additional information to perform regular string matching with the original document, as shown in a block 606 of FIG. 6. To perform the regular string matching, the processor 112 may match the startIndex, the endIndex, and contextual text (before and after the startIndex and the endIndex words) with the original document to confirm annotation process accuracy. In some aspects, the processor 112 may identify errors in annotation based on the matching, and may update the annotation performed by the LLM 106b (e.g., update the highlighted or underlined words) responsive to identifying the errors. When the processor 112 completes the annotation process, the processor 112 may transmit the annotation output to the user device 108 to display an annotation output 608 on the user interface 200, as shown in FIG. 6. The annotation output 608 may include the highlighted/underlined entity and corresponding entity tags. For instance, as shown in FIG. 6, the annotation output 608 may highlight the word “Mariana Greenway” in the document, and add a tag “Person: Mariana Greenway” to the word.

In accordance with further aspects of the present disclosure, the processor 112 may execute the instructions stored in the redaction module 128 to redact (e.g., remove or hide) sensitive information from one or more documents with higher levels of accuracy, thereby ensuring compliance and data security. In some aspects, the processor 112 may identify the sensitive information in the document and replace the sensitive information with non-sensitive information/counterpart called a token that has no inherent value. In some aspects, the processor 112 may store a mapping of token and respective sensitive data in the memory 114.

The sensitive information may include personally identifiable information (PII), financial information, medical information, and/or the like. For instance, the sensitive information may include name, email ID, medical records, transaction details, account number, credit card number, and/or the like. In some aspects, the user may request the processor 112 to redact the sensitive information from the document. The user request may include information associated with the document(s) from which the sensitive information needs to be redacted. The processor 112 may receive the user request, and may redact the sensitive information based on the user request.

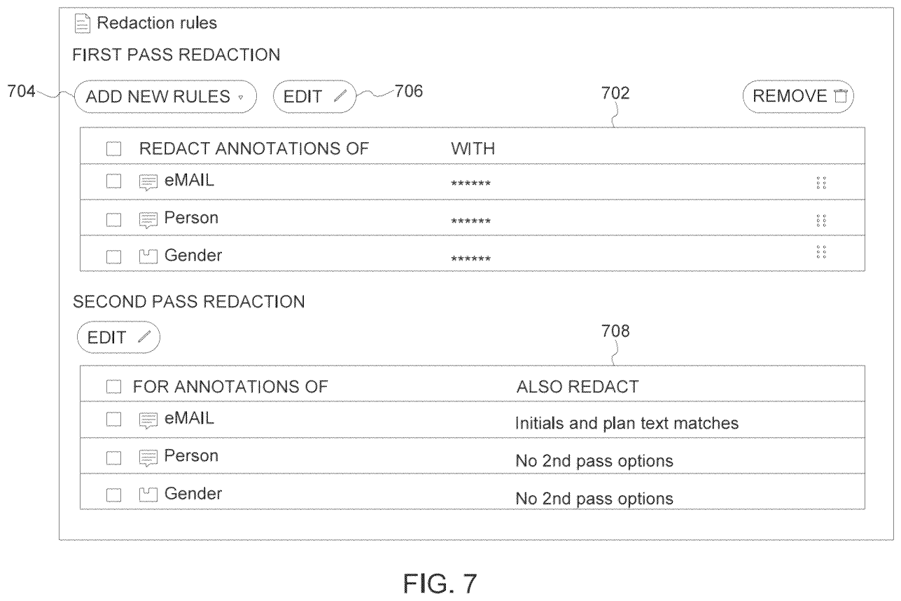

In some aspects, the processor 112 may receive the user request, and may enable the user to create user rules (e.g., for a “first pass redaction”) to redact the sensitive information, via the user interface 200. In some aspects, the user rules may include rules to redact the sensitive information (e.g., types of information that needs to be redacted). For instance, the user rules may include selection of text classes (or entity tags/labels) that needs to be redacted, which are shown in a view 702 of FIG. 7. The text classes (or entity tags/labels) may include, but not are limited to, email IDs, person name, gender, etc. In addition, the user rules may include a processor or “how” to redact the text classes selected by the user, by using the tokens. For instance, the user may provide an indication to redact all the text classes by a single special character (e.g., “*”). Alternatively, the user may provide an indication to redact different text classes with different special characters (e.g., email by “*”, person name by “!”, and/or the like). In some aspects, the user may create the user rules by using a drop shown button, shown as a “add new rule” button 704 in FIG. 7. The user may further edit existing rules by using an edit button 706.

When the user creates the user rules, the processor 112 may obtain the user rules from the user device 108, via the transceiver 110. The processor 112 may then parse the document(s), and identify annotations of the text classes (or annotation of the sensitive information that may have been performed by the LLM 106b, as described above) in the document(s) based on the user rules. To identify the annotation of the sensitive information, the processor 112 may perform word-by-word document(s) analysis. Responsive to identifying the annotations, the processor 112 may redact the identified annotations based on the user rules. Specifically, the processor 112 may replace the annotations of the sensitive information with the non-sensitive information (or tokens) indicated in the user rules. In some aspects, the processor 112 may perform real-time monitoring of the sensitive information in the document(s), and redact the sensitive information based on the real-time monitoring. The processor 112 may store the identified sensitive data tokens (or tokens associated with the identified annotations) in the memory 114. In some aspects, the processor 112 may store the identified sensitive data tokens responsive to replacing the sensitive information. For instance, when the processor 112 redacts the name “John Doe”, the processor 112 may store the token associated with the word “John Doe”.

In further aspects, to further improve the accuracy of redacting the sensitive information from the document, the processor 112 may enable the user to create/add additional rules to perform a special pass of redaction (or a “second pass redaction”), as shown in a view 708 of FIG. 7. The additional rules (associated with the second pass redaction) may consider the results of the first pass redaction, to increase the redaction accuracy. Specifically, the additional user rules may include suitable variations of the stored identified sensitive data tokens from the first pass redaction. The second pass redaction may be associated with the selected text classes (e.g., text classes or entity tags/labels selected by the user for the first pass redaction).

As an example, the user may create an additional rule to redact initials and plain text matches in the text class of “emails”. As another example, the user may create an additional rule to redact initials of “person name” (e.g., by using subparts of the identified sensitive data tokens, which corresponds to the initials of the person's name). For example, the user may create a rule to redact initials “JD” from the name “John Doe”. As yet another example, if someone's full name was given and flagged, where later in the document only the first name was given or even a variation of the first name (e.g. ‘Dave’ instead of ‘David’), the user (or the processor 112) may built a custom algorithm to make lists of all found tokens and then generate suitable variations of them (e.g. initials, acronyms, alternative spellings or short versions of the same text).

When the user creates the additional rules as described above, the processor 112 may obtain the additional rules from the user device 108, via the transceiver 110. The processor 112 may then parse or re-scan the document(s), and redact the document(s) based on the additional rules. Stated another way, the processor 112 may re-scan the redacted document looking for any examples of newly generated tokens (or identified sensitive data tokens from the first pass redaction) in the document(s). The second pass redaction may cause additional redaction and may not overwrite the redaction results of the first pass redaction. The processor 112 may then output the redacted document to the user device 108, via the transceiver 110, to display the output on the user interface 200. In this manner, the system 102 may enable the user to redact the documents in two passes or two steps, to accurately redact the sensitive information. In some aspects, the processor 112 may use natural language AI models (or LLMs) to perform the tasks described above. For instance, the processor 112 may leverage one or more AI models to identify the sensitive information with high accuracy and efficiency.

In further aspects, the processor 112 may perform the redaction based on a prioritization mechanism that would enable certain sensitive tokens to remain in the document. The processor 112 may enable certain sensitive tokens to remain in the document if they were important for the document output and their sensitivity rating is below a certain threshold level. For example, if a person was mentioned and was then the subject of a neighboring sentence, the reader would have to know that these two sentences referred to the same person. Therefore, if the names were not to be replaced by meaningless tokens, they would have to stay in the document. For these cases, the prioritization mechanism may enable certain sensitive tokens to remain in the document.

In accordance with further aspects of the present disclosure, the processor 112 may execute the instructions stored in the data discovery module 130 to perform data discovery of the documents at a large scale. The data discovery module 130 may be a module that crawls the data sources, and fetch metadata of every document/file in the data source. The data discovery module 130 may include instructions that would recursively call the root folder, the sub folders, the sub-sub folder, collecting metadata about all the files along the way. Data discovery helps organizations understand what data they have and how to use it to drive value. The processor 112 may leverage machine learning and natural language processing techniques to extract meaningful insights from unstructured data.

In addition, the system 102 may include a searchable index that enables the user to search specific information in a plurality of documents, filter content, and/or the like. For instance, the user may extract documents that were indexed in the last 3 months or the documents that contain a specific person name.

Further, the system 102 may include a custom monitoring solution that may enable the system 102 to monitor and intricately understand the system performance and behavior, and summarize the system behavior without impacting system performance. Based on the inputs from the custom monitoring solution, the system 102 may derive actionable insights that may enable the system 102 to iteratively restructure the system's existing infrastructure to enhance the system performance. For example, the system 102 may identify system limitations based on the inputs obtained from the custom monitoring solution and may iteratively restructure the system's existing infrastructure to enhance the system performance. In some aspects, the custom monitoring solution may leverage a technology stack mainly of Java and Python programming languages, ElasticSearch, Logstash, Kibana and Grafana to monitor and represent the speed, accuracy and throughput during the document download and network transfer, the upload and metadata identification, the tokenisation and natural language processing (NLP), and the classification and labelling stages of the system processes. In addition, the system 102 may leverage the Kubernetes container orchestration engine to enable better management of resources, and aid in additional scaling based on performance and cost.

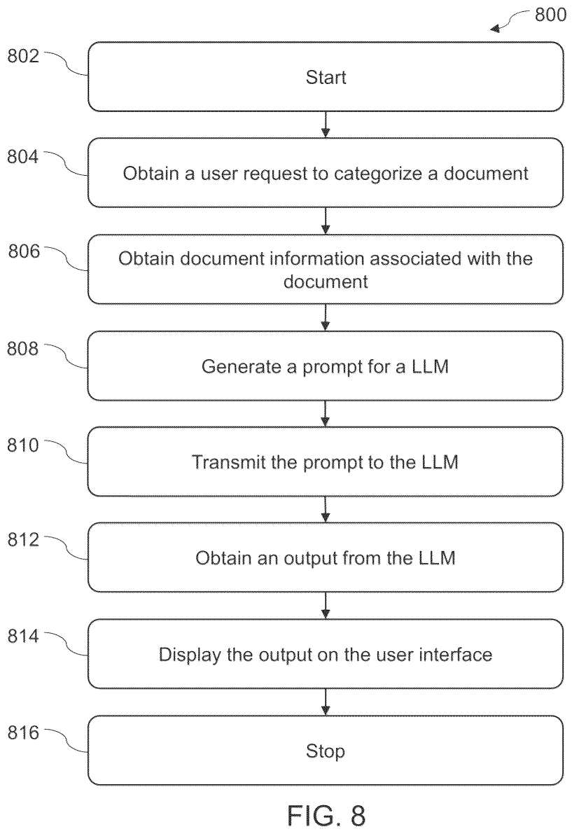

FIG. 8 depicts a flow diagram of a method 800 to perform data management in accordance with the present disclosure. FIG. 8 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 800 starts at step 802. At step 804, the method 800 may include obtaining, via processor 112 and the categorizer module 124, the user request to categorize a document (or a plurality of documents) from the user interface 200. As described above, the user request may include the list of categories, where each category includes a category name and category description/characteristics.

At step 806, the method 800 may include obtaining, via the processor 112 and the categorizer module 124, document information associated with the document to be categorized responsive to obtaining the user request. At step 808, the method 800 may include generating, via the processor 112 and the categorizer module 124, a prompt for the LLM 106a based on the user request. The prompt may include the list of categories and the document information.

At step 810, the method 800 may include transmitting, via the processor 112 and the categorizer module 124, the prompt to the LLM 106a to identify a category for the document from the list of categories. At step 812, the method 800 may include obtaining, via the processor 112 and the categorizer module 124, an output from the LLM 106a responsive to transmitting the prompt. At step 814, the method 800 may include displaying, via the processor 112 and the categorizer module 124, the output on the user interface 200.

At step 816, the method 800 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to obtain a user request to categorize a document via a user interface, wherein the user request comprises a list of categories to categorize the document; and
a processor configured to:
obtain the user request from the transceiver;
obtain first document information associated with the document to be categorized responsive to obtaining the user request;
generate, via a categorizer module, a prompt for a large language model (LLM) based on the user request, wherein the prompt comprises the list of categories and the first document information;
transmit, via the categorizer module, the prompt to the LLM to identify a category for the document from the list of categories;
obtain, via the categorizer module, an output from the LLM responsive to transmitting the prompt; and
display, via the categorizer module, the output on the user interface.

2. The system of claim 1, wherein the prompt is a generalized prompt in natural language.

3. The system of claim 1, wherein each category in the list of categories comprises a category name and category description or characteristics.

4. The system of claim 1, wherein the first document information associated with the document comprises a first document path.

5. The system of claim 1, wherein the first document information associated with the document comprises a text string representing content of the document.

6. The system of claim 1, wherein the prompt further comprises a first instruction to select a category from the list of categories to categorize the document.

7. The system of claim 1, wherein the prompt further comprises a second instruction to add a new category to the list of categories when the list of categories is not relevant for the document.

8. The system of claim 1, wherein the prompt further comprises a third instruction to modify a category of the list of categories.

9. The system of claim 1, wherein the prompt further comprises second document information associated with a set of previously categorized documents.

10. The system of claim 9, wherein the second document information associated with each previously categorized document comprises a second document path and an associated category name.

11. The system of claim 1, wherein the output comprises a category name for the document.

12. The system of claim 11, wherein the output further comprises a mapping of a document identifier associated with the document with a corresponding category name.

13. The system of claim 1 further comprising a memory configured to store the prompt and the output.

14. The system of claim 13, wherein the memory is further configured to store the document and the first document information, and wherein the processor is configured to obtain first document information from the memory.

15. The system of claim 1, wherein the system is communicatively coupled with a plurality of data sources and a plurality of LLMs.

16. A method comprising:
obtaining, by a processor, a user request to categorize a document via a user interface, wherein the user request comprises a list of categories to categorize the document;
obtaining, by the processor, first document information associated with the document to be categorized responsive to obtaining the user request;
generating, by the processor, a prompt for a large language model (LLM) based on the user request, wherein the prompt comprises the list of categories and the first document information;
transmitting, by the processor, the prompt to the LLM to identify a category for the document from the list of categories;
obtaining, by the processor, an output from the LLM responsive to transmitting the prompt; and
displaying, by the processor, the output on the user interface.

17. The method of claim 16, wherein each category in the list of categories comprises category name and category description or characteristics.

18. The method of claim 16, wherein the first document information associated with the document comprises a first document path and a text string representing content of the document.

19. The method of claim 16, wherein the prompt further comprises second document information associated with a set of previously categorized documents, and wherein the second document information associated with each previously categorized document comprises a second document path.

20. A non-transitory computer-readable storage medium having instructions stored thereupon which, when executed by a processor, cause the processor to:
obtain a user request to categorize a document via a user interface, wherein the user request comprises a list of categories to categorize the document;
obtain document information associated with the document to be categorized responsive to obtaining the user request;
generate a prompt for a large language model (LLM) based on the user request, wherein the prompt comprises the list of categories and the document information;
transmit the prompt to the LLM to identify a category for the document from the list of categories;
obtain an output from the LLM responsive to transmitting the prompt; and
display the output on the user interface.
